(19) United States
(12) Patent Application Publication
(10) Pub. No.: US 2003/0202685 A1
(43) Pub. Date: Oct. 30, 2003

(54) ID information forming apparatus, ID information forming method and ID card preparing system

(75) Inventors: Atsuhiro Shimizu, Tokyo (JP); Taketo Nozu, Tokyo (JP); Setsuo Itoh, Tokyo (JP)

Correspondence Address: Finnegan, Henderson, Farabow,, Garrett & Dunner, L.L.P., 1300 I Street, N.W., Washington, DC, 20005-3315, US

(73) Assignee: KONICA CORPORATION

(21) Appl. No.: 10/420,691

(22) Filed: Apr. 23, 2003

(30) Foreign Application Priority Data
Apr. 26, 2002 (JP) JP2002-126235

(51) Int. Cl. G06K 9/00

(52) U.S. Cl. 382/118

(57) ABSTRACT

The present invention relates to an ID information forming apparatus for making ID information to prepare an ID card. The apparatus comprises: an image taking section to take a facial image of a person, and to make a first facial image data corresponding to the facial image of the person; an image information forming section to make first image information from the first facial image data; an information acquiring section to acquire second image information regarding a second facial image data corresponding to a past facial image of the person; a checking section to check the first image information against the second image information; an eye-opening degree judging section to judge a degree of eye-opening of the first facial image data; and an ID information forming section to form the ID information based on results of checking by the checking section and of judging by the eye-opening degree judging section.

### TECHNICAL FIELD

The present invention relates to an ID information forming apparatus to form ID information for preparation of ID cards, an ID information forming method utilizing the apparatus and an ID card preparing system utilizing the apparatus.

### BACKGROUND

In recent years, in widespread use are various kinds of ID cards such as driver's licenses, identification cards, passports, alien registration cards, library cards, cash cards, credit cards, employee identification cards, company staff identification cards, membership cards, medical service cards, and student identification cards. These ID cards are made of paper or plastic, on one or both surfaces of which personal data is directly printed, or IC cards in which a built-in memory stores the foregoing personal data. In many cases, a facial photographic image is printed or pasted on the card's surface. Recently, along with expanded use and technical progress of digital cameras, facial images during preparation are printed on the ID card surface, based on digital image data.

At the time of taking facial image, the operator of the image taking apparatus adjusts the facial image on a monitor to determine whether it is adequate for the ID card, whether the person closed his/her eyes or laughed, whereby if the image is inadequate for the ID card, the operator can repeat the procedure.

Further, during the renewal process the operator confirms the person's identity by comparing the facial image on the expired ID card with the person at the time of ID card renewal.

However, in case of the foregoing image taking apparatus, since the operator himself of the image taking apparatus judges whether the picture is adequate or not for the ID card, it can be a problem that a heavy responsibility bears on the operator.

Further, since a confirmation of the person is conducted by the operator himself engaging in the renewal process, if can also be a heavy burden. Specifically, the facial image on the ID card tends to be small and unclear, and thus, when said operator conducts the confirmation process, the confirmation process sometimes become ineffective and can be a problem. Still further, during ID card renewal, in case the foregoing judgment of eye-opening are conducted in addition to the personal confirmation, the time required for the renewal tends to extend and it may become a problem.

### SUMMARY

An aspect of the present invention is to increase the operational efficiency of the image taking process of a facial image utilized for renewal of an ID card by automating an eye-opening judging process for the facial image, as well as a checking process to checking a current facial image with the past facial image. Further, the operational efficiency may be increased by conducting the eye-opening judging process and the checking process, concurrently.

The above aspects of the invention can be achieved by following embodiments.

One embodiment of the present invention is an ID information forming apparatus for making ID information to prepare an ID card. The ID information forming apparatus comprises an image taking section to take a facial image of a person, and to make a first facial image data corresponding to the facial image of the person. The apparatus further comprises an image information forming section to form first image information from the first facial image data. The apparatus still further comprises an information acquiring section to acquire second image information regarding a second facial image data corresponding to a past facial image of the person. The apparatus still further comprises a checking section to check the first image information against the second image information. The apparatus still further comprises an eye-opening degree judging section to judge a degree of eye-opening of the first facial image data. The apparatus still further comprises an information forming section to form the ID information based on result of checking by the checking section and of judging by the eye-opening degree judging section.

Another embodiment of the present invention is an ID information forming method utilizing the above-described ID information forming apparatus. The method comprises the steps of taking a facial image of a person, and making a first facial image data corresponding to the facial image of the person by the image taking section. The method further comprises making first image information from the first facial image data by the image information forming section. The method still further comprises acquiring second image information regarding a second facial image data corresponding to a past facial image of the person by the information acquiring section. The method yet further comprises checking the first image information against the second image information by the checking section. The method yet further comprises judging a degree of eye-opening of the first facial image data by the eye-opening degree judging section. The method yet further comprises forming ID information to prepare an ID card by the information forming section based on results of checking and judging.

It is preferable that the steps of checking and judging are conducted, concurrently.

Still another embodiment of the invention is an ID card preparing system comprising the above-mentioned ID information forming apparatus, an image server to store a second facial image data corresponding to the past facial image of the person, and a printer to print the ID information on the ID card substrate.

According to the above-described embodiments, it is possible to reduce the operator's burden during ID card renewal. Further, it become possible to shorten the time for the image taking procedure by simultaneously carrying out the eye-opening degree judgment of the taken facial image and the checking the facial image against the previous one, resulting in an increase of operational efficiency of the image taking procedure.

In the present invention, it is preferable that the ID information forming apparatus comprises a facial image determining section to determine whether the first image information and the second image information being relative to a face of the same person or not based on a result of checking by the checking section. When the facial image determining section determines the first image information and the second image information are relative to the face of same user, the information forming section forms the ID information.

Correspondingly, in the present invention, it is preferable that the ID information forming method further comprises determining whether the first image information and the second image information being relative to a face of the same user or not by a facial image determining section based on a result of the step of checking. When the first image information and the second image information are relative to the face of same user, the ID information is formed by the information forming section.

According to the invention, preparation of an abusive ID card can be totally prevented, and also ensure high reliability of security from the point of view during ID card renewal, by determining whether the facial image of the expired ID card obtained from the server and the facial image currently taken during renewal are the same person or not.

In the invention, it is preferable that the image taking section takes plural images of the person and makes plural first facial image data, and then, the eye-opening degree judging section judges the degree of eye-opening of the plural first facial image data. The ID information forming apparatus further comprises an extracting section to extract a facial image data utilized to form the ID information from the plural first facial image data, and the information forming section forms the ID information by utilizing the extracted facial image data.

Correspondingly, in the invention, it is preferable that in the step of taking the facial image, plural facial images are taken;

in the step of making the first facial image data, plural first facial image data are made;

in the step of judging the degree of eye-opening, the plural first facial image data are judged;

the ID information forming method further comprises extracting a facial image data utilized to form the ID information from the plural first facial image data; and

in the step of forming the ID information, the ID information is formed by utilizing the extracted facial image data.

According to the invention, it become possible to select an optimal facial image without closed eyes by the eye-opening degree judgment, and also to output the facial image which is most suitable to use for the ID card.

In the present invention, it is preferable that the ID information forming apparatus further comprises a position adjusting section to adjust a position of the image taking section so as to locate a face of the person in a predetermined area, and comprises a image taking ordering section to order the image taking section to take the facial image when the face of the user being located in the predetermined area.

Correspondingly, in the invention, the ID information forming method further comprises:

adjusting a position of the image taking section so as to locate a face of the person in a predetermined area; and

ordering the image taking section to take the facial image when the face of the person being located in the predetermined area.

According to the invention, it is possible to shorten the time for the photographic procedure and also to reduce the operator's load, who handles the image taking apparatus, from the responsibility of adjusting the camera position to place the applicant's face in a predetermined area before ordering image-taking.

### BRIEF DESCRIPTION OF THE DRAWINGS

FIG. 1 a block diagram showing a configuration of ID Card Preparing System 100 applied the embodiments of the present invention.

FIG. 2 a block diagram showing the basic configuration of Image taking System S including ID Information Forming Apparatus 4 applied to the present invention, and exemplified structures of the ID Information Forming Apparatus 4.

FIG. 3 a flow chart showing operation of ID Card Preparing System 100 during ID card renewal.

FIG. 4 another flow chart showing operation of ID Card Preparing System 100 during ID card renewal.

### PREFERRED EMBODIMENTS OF THE INVENTION

Preferred Embodiments of the present invention are detailed below with referring to drawings. Now, in the following embodiments, ID Card Preparing System 100 will be described primarily for ID cards (e.g., employee certification cards, employee ID cards) of company employees, but it is not limited to these cases. The present invention can be applied to a corporation's management and controlling of specified qualifications. In this case, ID Card Preparing System 100 prepares ID cards (e.g., license qualification cards) issued to qualified persons.

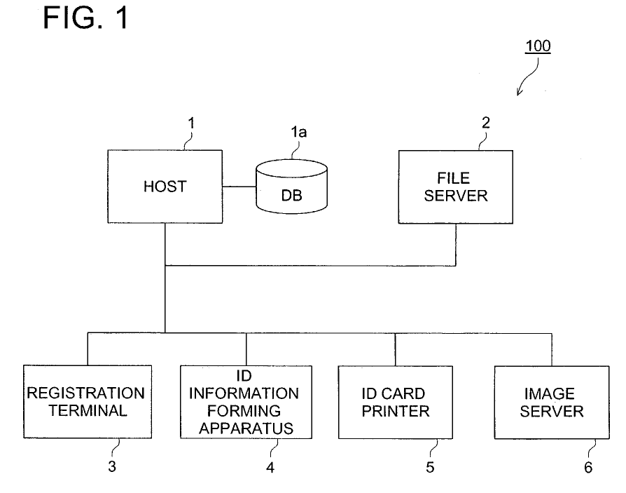

In the first instance, the main configuration will be described. FIG. 1 is a block diagram showing a schematic outline of the ID card preparing system applied the embodiments of the present invention. As shown in FIG. 1, ID card preparing system 100 comprises Host 1 featuring DB (Data Base) 1a, File Server 2, Registration Terminal 3, ID Information Forming Apparatus 4, ID Card Printer 5, and Image Server 6, and each apparatus except DB 1a is connected to each other by a communications network such as a LAN (Local Area Network).

Host 1 has DB (Data Base) 1a, and thus, stores the personal information inputted from Registration Terminal 3 in DB 1a corresponding to each company employee's ID number, together with various distinctive information [for instance, information whether an IC card is requested or not, information of ID card type (e.g., employee certification cards, employee ID card, or career certification cards), or a version information indicating changes before or after system revision]. Further, Host 1 controls renewal or readout of information stored in DB 1a.

File Server 2 stores personal information, various distinctive information, and image information of persons' facial images and application forms, transmitted from ID Information Forming Apparatus 4 to ID Card Printer 5, based on the ID number.

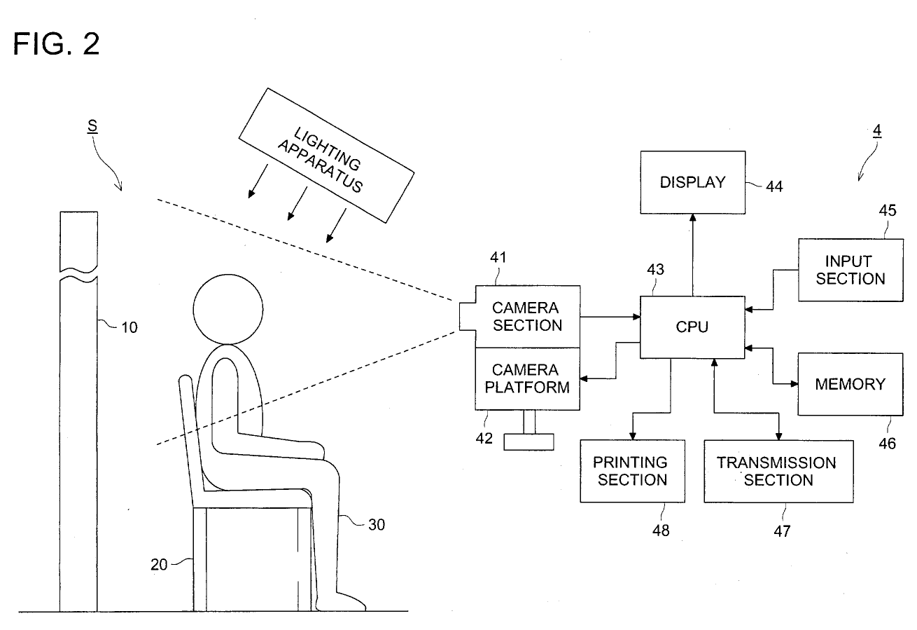

Registration Terminal 3 is a terminal to input employee's personal information, renewal information, the type of ID card, changed items of system revisions, comprising input devices such as a keyboard to input the ID number and the various foregoing information, an IC Card Reader (IC Card R/W) to read the ID number and others recorded on an IC chip on the IC card, and an OCR (Optical Character Reader) to read printed ID numbers. The configuration description of ID Information Forming Apparatus 4 will be explained later together with FIG. 2.

ID Card Printer 5 receives various personal information (the ID number, name, and division) and image information of the facial image from ID Information Forming Apparatus 4, and then, prepares the ID card based on the received information.

Image Server 6 stores each employee's corresponding ID number and facial image data, and conducts a face detection process of a designated ID number's facial image data. A face detection process is referred to as the process to detect a facial outline and positions of such as eyes, nose and mouth from luminance transition and change in hue of image data. The positions of eyes, nose, and mouth can be converted to facial characteristic points. Further, Image Server 6 calculates facial characteristic factors from the facial characteristic points detected by the facial detection process based on a predetermined calculation formula.

FIG. 2 is a block diagram showing the substantial configurations of Image taking System S including ID Information Forming Apparatus 4 of the present invention, and exemplified fundamental structures of ID Information Forming Apparatus 4. Image taking System S comprises ID Information forming Apparatus 4, Background Board 10, Chair 20, and a lighting apparatus.

ID Information Forming Apparatus 4 is an image taking apparatus installed in a photo studio and comprises Camera (Image Taking) Section 41, Camera Platform 42, CPU 43, Display 44, Input Section 45, Memory 46, Transmission Section 47, and Printing Section 48 as shown in FIG. 2.

Camera (Image Taking) Section 41 comprises an optical glass or plastic lens, and an optical sensor such as a CCD (Charged Couple Device) and a CMOS (Complementary Metal-Oxide Semiconductor), which forms the image data by converting a static image (the facial image of Person 30 sitting on Chair 20) inputted through an optical lens, to an electrical signal via an optical sensor. Camera Section 41 is supported by Camera Platform 42. This Camera Section 41 functions as the image taking section in the invention.

Camera Platform 42 is a device to support Camera Section 41, and shifts it up and down (vertical direction) based on control signals from CPU 43. This Camera Platform 42 functions as the position adjusting section in the invention.

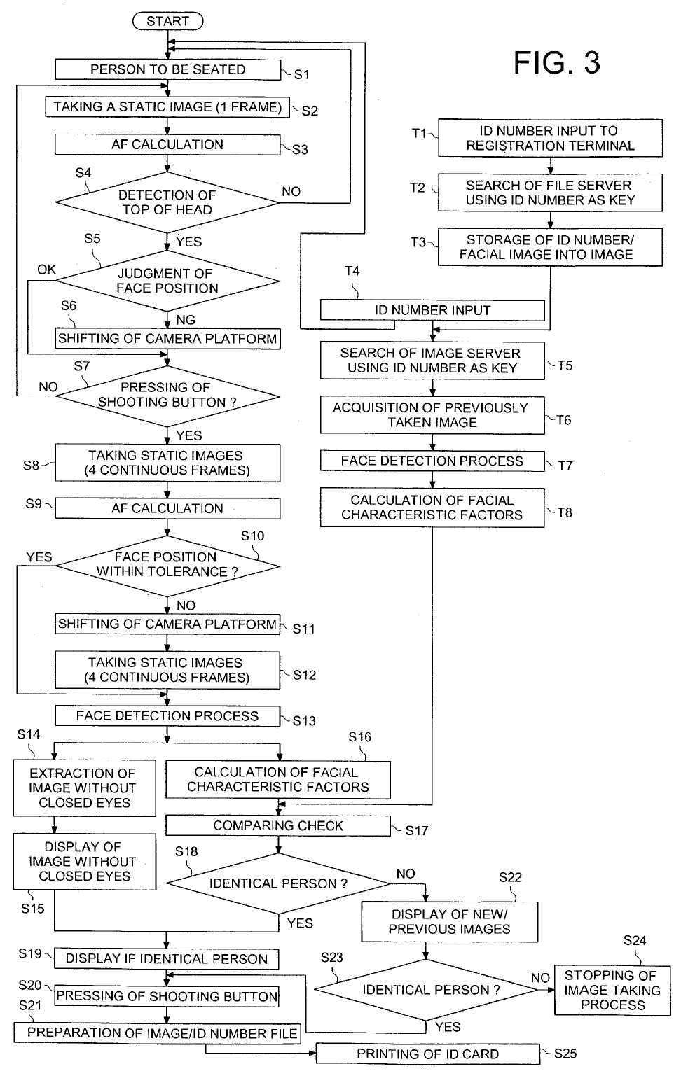

CPU (Central Processing Unit) 43 performs various control operations according to the control program for the ID information forming apparatus stored in Memory 46. Exemplary, the facial image data of Person 30 is prepared by Camera Section 41 in plural frames (for example, 4 frames) during ID card renewal. CPU 43 performs the face detection process of the obtained facial image data, and calculates the total facial characteristic factors from the face position (facial characteristic points) detected by the face detection process, and then compares the factors with the facial characteristic factors obtained from Image Server 6. Thus, CPU 43 can determine whether both facial image data are of the same person or not. Further, CPU 43 performs the eye-opening degree judgment to judge the degree of eye closure in each of the foregoing plural facial image data, along with the determining process of those facial images. (Ref. FIG. 3)

Furthermore, CPU 43 conducts AF (auto framing) calculation to determine the camera transfer distance of Camera Section 41, so as to place the facial image of Applicant 30 into the predetermined area of the frame during the AF (auto framing) process based on the obtained image data, after image taking of the facial image of Person 30. Also this CPU 43 may has functions as an image information forming section, a checking section, an eye-opening degree judging section, an ID information forming section, a facial image determining section and an extracting section in the present invention.

Display 44 features a CRT (Cathode Ray Tube) or LCD (Liquid Crystal Display), and exhibits the optimal display based on display control signals outputted from CPU 43.

Input Section 45 may comprise a keyboard to input the employee's ID number and the various other foregoing information, an IC card reader (IC card R/W) to read the ID number recorded on an IC chip in an IC card, an OCR to read the printed ID number, and various buttons such as a shooting button to order image taking and a confirmation button to confirm the image exhibited on Display 44. This Input Section 45 functions as a image taking ordering section in the invention.

Memory 46 stores various control programs executed by CPU 43 and data for various operations in advance. Further, Memory 46 temporarily stores the image data obtained from Camera Section 41 and calculation results from CPU 43.

Transmission Section 47 is an interface connectable to transmission media connected to communication networks such as a LAN and WAN (Wide Area Network), and comprises a Modem (MOdulator/DEModulator) and a Terminal Adaptor, and thus performs communication control with these exterior devices connected to the communication network via telephone lines, ISDN lines or leased lines. This Transmission Section 47 may have a function as information acquiring section in the invention.

Printing Section 48 provides a paper feeding unit and a paper ejecting unit for printing paper (neither of which are illustrated), and outputs the facial image on the foregoing print paper using a sublimation method based on control signals outputted from CPU 43. An ink-jet method and an electrophotography method using projection light such as infrared laser light and LED (Light-Emitting Diode) may be employed as a printing method.

In FIG. 2, Background Board 10 provides a neutral background for Person 30 during image taking with ID Information Forming Apparatus 4. The Board is of a single color of uniform reflectance. Chair 20 is a seat for the positioning of Person 30 during image taking of the facial image of Person 30. A typical lighting apparatus illuminates Applicant 30 sitting on Chair 20 during image taking.

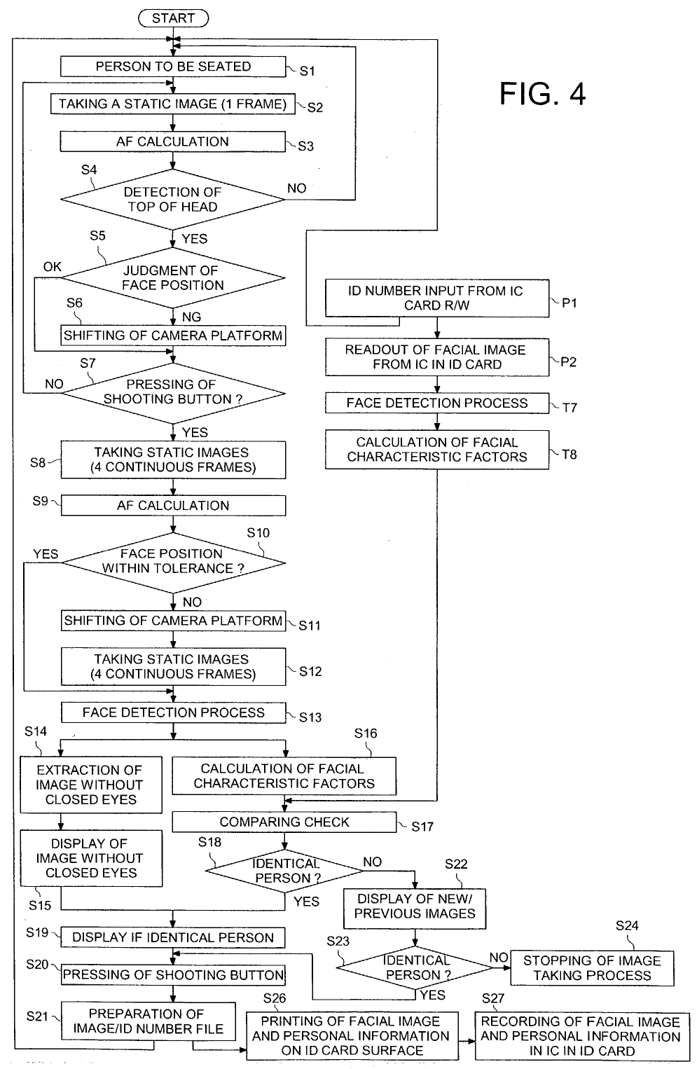

The embodiment of the operation will be described. The operation of ID card preparing system 100 will be described as for ID card renewal, referring to flowcharts in FIGS. 3 and 4.

Firstly, operation when an employee's ID number is inputted from Registration Terminal 3 is described, referring to the flowchart in FIG. 3.

As the first step, an employee's ID number is inputted with the input device of Registration Terminal 3 (Step T1), and that ID number is transmitted to File Server 2. File Server 2 searches for the facial image data stored within it using the ID number received from Registration Terminal 3 as a search key (Step T2), and selects the facial image data corresponding to that ID number.

The facial image data selected from File Server 2 is transmitted to Image Server 6. Image Server 6 stores the facial image data received from File Server 2 with connecting with the ID number. (Step T3)

When the ID number on the ID card, brought in by the employee, is inputted from Input Section 45 of ID Information Forming Apparatus 4 during ID card renewal (Step T4), that ID number is transmitted to Image Server 6, and at the same time it is transferred to Step S1. Image Server 6 searches the facial image data stored in Image Server 6 using the ID number as a key, and extracts and obtains the image data corresponding to that ID number (Step T6). The facial image data selected in Step T6 is the employee's past facial image taken during previous ID card procedure.

Consequently, Image Server 6 conducts the face detection process to the facial image data selected in Step T6 (Step T7). Further, Image Server 6 calculates the total face feature factors from the face position detected by Step T7 (Step T8), and transmits the calculated result to ID Information Forming Apparatus 4. It is also possible that ID Information Forming Apparatus 4 may perform the face detection process in Step T7 and the feature factor calculation in Step T8.

Next, the image taking process of ID Information Forming Apparatus 4 will be described. Hereinafter, the employee taken a facial image for ID card renewal is referred to as Person 30.

After the power source of the ID Information Forming Apparatus is switched on and the employee's ID number is inputted from Input Section 45 (Step T4), and the seating of Person 30 is detected (Step S1), Camera Section 41 takes Person 30's image in one frame (Step S2). ID Information Forming Apparatus 4 acquires the employee's personal information corresponding to that ID number from DB 1a provided in Host 1, based on the ID number input by Input Section 45.

The image, taken by Camera Section 41 during the imaging in Step S2 is stored in Memory 46 as image data.

CPU 43 starts AF (auto framing) calculation based on the photographed image data stored in Memory 46 (Step S3). In this AF calculation, CPU 43 detects the top of the Person 30's head (Step S4; Yes), and calculates the camera transfer distance of Camera Section 41 based on the detected place of the head top. This transfer distance is the distance necessary to place Person 30's face into the center of the frame.

The detection of the top of the Person 30's head in Step S4 is accomplished, for example, by detection of luminance transition based on the obtained image data of Person 30. The image data corresponding to Background Board 10 has uniform luminance, but the image data corresponding to the person has different luminance from that of the Background Board 10 data. Therefore, the outline of the applicant figure can be detected.

If the Person 30's head top is not detected (Step S4; No), CPU 43 returns to Step S1. Then, if the top of the Person 30's head is detected (Step S4; Yes), CPU 43 judges whether the current camera position is adequate for image taking of the facial image for the ID information, based on whether Person 30's face is within the predetermined area in the frame based on the detected top of the head position (Step S5). The predetermined area means an area defined in advance as an image taking area for the facial image taking. This area assures the space of the predetermined range (e.g., 4-6 mm) between the top of the head and the uppermost edge of the frame.

In cases where the current camera position is not adequate for imaging of a facial image for the ID information in Step S5 (Step S5; NG), CPU 43 causes Camera Platform 42 to shift by outputting control signals to Camera Platform 42 to move the camera by the transfer distance calculated in Step S3 (Step S6), and subsequently waits the pressing of the shooting button of Input Section 45 (Step S7).

If Person 30's facial position is placed in the given area in the frame and the current camera position is adequate for imaging of the facial image for the ID information in Step S5 (Step S5; OK), CPU 43 transitions to Step S7 by outputting a display control signal showing the facial image position being adequate to Display 44, and waits the pressing of the shooting button of Input Section 45 by the operator. In cases when the shooting button is not pressed down in Step S7 (Step S7; NO), ID Information Forming Apparatus 4 repeats the processes of Steps S1 through S6.

The ID number on the ID card brought in by Person 30 is inputted in Input Section 45 (Step T3), and when the shooting button is pressed down by the operator, who has confirmed that the facial image position exhibited on Display 44 was satisfactory in Step S7, Camera Section 41 captures the image of Person 30 in 4 continuous frames (Step S8). The obtained image taken in from Camera Section 41 via imaging in Step S8 is stored in Memory 46 as image data.

Then, CPU 43 conducts AF calculation based on the image data of the first of the 4 frames obtained in Step S8 (Step S9). Then, CPU 43 judges whether any deviation of the facial position is within the predetermined tolerance or not by comparing the calculated result of the AF calculation in Step S3 with the result of the AF calculation in Step S9, and also by comparing Person 30's facial position just before the activation of the shooting button with that immediately after the activation (Step S10). Here, the term of the predetermined tolerance means that the facial position does not exceed the range of the above-mentioned predetermined area with any deviation of the facial position.

In Step S10, if the deviation of the facial position is judged to be beyond the predetermined tolerance (Step S10; NO), CPU 43 repositions Camera Platform 42 by outputting control signals to Platform 42, which signal indicates the actual camera transfer by the transfer distance calculated in Step S9 (Step S11). After the transfer of Platform 42, Camera Section 41 captures the Person 30's image in 4 continuous frames (Step S12). The obtained images taken in from Camera Section 41 with the imaging in Step S12 is stored in Memory 46 as image data.

In Step S10, any deviation of the facial position is judged to be within the predetermined tolerance (Step S10; YES), or, in Step S12, if the Person 30's image is taken in 4 frames, CPU 43 conducts the face detection process with the 4 images of Person 30 stored in Memory 46 (Step S13).

Subsequently, CPU 43 detects the feature points of eyes in the foregoing image data of the 4 frames to judge the degree of eye-opening in each frame, and thus selects the image without closed eyes from those 4 images (Step S14). Specifically, CPU 43 detects the position of the feature points of eyes (the center, cheek end and nose end), and inputs it into the neural network, providing the predetermined conversion to the image information of these feature points of eyes.

The neural network outputs the status of the eye openings, adequately analyzing the information provided the predetermined conversion to the image information of the feature points of eyes of each foregoing image. CPU 43 selects the facial image with the most opened eye as the optimal image, judging from the eye status of each image output from the neural network, and outputs the control signals to indicate exhibition of the selected facial image to Display 44. Display 44 exhibits that facial image based on the display control signals outputted from CPU 43 (Step S15).

However, the extraction method of the image without closed eyes in Step S14 is not limited to the foregoing one, but for example, also employed may be the facial image with the largest open eyes selected as the image without closed eyes from the 4 images, calculating the open eye area from the extracted feature factor of eyes which has been retrieved from luminance transition of the image data.

Along with the extraction of the image without closed eyes in Step S14, CPU 43 calculates the total facial characteristic factor from Person 30's image data stored in Memory 46 (Step S16). Further, CPU 43 conducts check of the facial characteristic factor corresponding to the foregoing ID number received from Image Server 6 (that is, the facial image characteristics data calculated from Image Server 6 in Step T8) against the facial characteristic factor calculated in Step S16 (Step S17).

In the check result in Step S17, if the consistent rate is higher than the predetermined value, and the facial image stored in Image Server 6 and the foregoing obtained facial image are judged to be the same person (Step S18; YES), CPU 43 outputs the display control signal to Display 44, both facial images being Person 30 own facial images, and thus, Display 44 displays, for example, “Identical Person” or “OK”, according to the display control signal outputted from CPU 43 (Step S19). At this time, the optimal image without closed eyes is also displayed on Display 44.

Next, if the confirmation button of Input Section 45 is activated by the operator of ID Information Forming Apparatus 4 (Step S20), CPU 43 prepares the file including ID information corresponding to the personal information acquired in Step T4 with the facial image displayed on Display 44 (Step S21). Meanwhile, the file including ID information prepared in Step S21 is transmitted to ID Card Printer 5 for ID card printing, and the facial image and the personal information are printed on the surface of the ID card by ID Card Printer 5 (Step S25). Further, the file prepared in Step S21 is registered in File Server 2.

In the result of the check in Step S17, if the consistent ratio is lower than the predetermined value, and the facial image stored in Image Server 6 and the foregoing obtained facial image are judged to not be the same person (Step S18; NO), CPU 43 outputs the display control signal to Display 44, which prompts display of the facial images corresponding to the above ID number acquired from Image Server 6 (past facial image) and the facial image obtained in Step S8 or Step S12 (current facial image). Display 44 displays the past facial image and the current facial image based on the display indication signal (Step S22). However, the facial image displayed in Step S22 may be only the past facial image.

The operator of ID Information Forming Apparatus 4 judges whether both facial images are of the same person, that is, if Person 30's own facial image is identical to that based on the old and new facial image displayed on Display 44 (Step S23).

In Step S23, if the past and current facial images are judged to be Person 30 (Step S23; YES), the confirmation button is activated by the operator (Step S20), and CPU 43 prepares a file corresponding to the current optimal facial image to the appropriate ID number (Step S21).

If in Step S23, the past facial image is judged not to be Person 30 (Step S23; NO), a warning screen is shown on Display 44 based on the operator's keyed input, and the current picture-taking process is cancelled (Step S24), and replaced by a subsequent picture-taking process.

Next, the operation will be detailed when the employee's ID number is input from an IC card R/W, referring to the flow chart of FIG. 4. In the flow chart, Steps T7, T8, and S1 through S24 are the same as in the flow chart of FIG. 3, and thus the description of this portion is omitted and only the portions different from FIG. 3 will be described.

When the ID number of the renewing employee's ID card is inputted from the IC card R/W comprising Input Section 45 (Step P1), that employee's facial image is readout from the IC on the ID card (Step P2), accompanied with the above-mentioned Step S1. Further, that employee's ID information is obtained from the IC on the ID card with the ID number input in Step P1. In Step P2, when the facial image is readout from the IC on the ID card, the face detection process to that facial image is conducted in the ID Information Forming Apparatus 4 or Image Server 6 as being the same as in the flow chart of FIG. 3 (Step T7), after which the total facial characteristic factors are calculated (Step T8).

In Step S21, if the file comprising the personal information obtained with the ID number input in Step P1 and a facial image without closed eyes displayed on Display 44, the personal information and the facial image are connected with, is prepared, this prepared file is transmitted to ID Card Printer 5 for ID card printing, and thus, the facial image and the personal information are printed onto the ID card surface (Step S26), and that facial image and the personal information are written into the IC in the ID card (Step S27). In this manner, the ID information in the ID card (the facial image and the personal information) can be utilized at the next renewal, by writing in the facial image and the personal information into the IC in the ID card.

As described above, according to ID Information Forming Apparatus 4 of the embodiment, the automated eye-opening confirmation of the obtained facial image and the automated check of the identical person can be conducted simultaneously (Steps S14 through S17 in FIG. 3), and thus, the burden on the operator working on renewal operation can be reduced, and the time for the image taking procedure can be shortened, resulting in an increase of the operational efficiency of the image taking procedure. Specifically, selecting the image without closed eyes using the automated eye-opening judgment leads to the output of acceptable images for the ID card. Further, in cases when the facial characteristics factor of the facial image obtained previously is calculated by Image Server 6 for check of the facial images, the load on ID Information Forming Apparatus 4 is also reduced.

Further, the time for image taking may be shortened by framing Person 30's facial image in the predetermined area in the frame at the time of the shooting, eliminating the need of camera position shifting, if the AF process is conducted before the shooting indication by the activation of the shooting button.

Furthermore, it becomes constantly possible to taking an image at an optimal camera position for the facial image taking by readjusting the camera position even when the person's face is out of the frame area at the shooting order.

The description of the embodiments is not limited to the above-mentioned paragraphs, but various changes may be made without departing from the scope of the invention.

### EFFECTS OF THE INVENTION

According to the inventions, it is possible to reduce the operator's burden during ID card renewal, and to shorten the time for the image taking procedure by simultaneously carrying out the eye-opening judgment of the obtained facial image and the check of the facial image with the previous one, resulting in an increase of operational efficiency of the image taking procedure.

Further, according to the invention, preparation of an abusive ID card can be totally prevented, and also ensure high reliability of security from the viewpoint during ID card renewal, by judging whether the past facial image of the expired ID card obtained from the server and the facial image currently being taken during renewal are the same person.

Still further, according to the invention, it is possible to select an optimal facial image without closed eyes by the eye-opening judgement, and also to output the facial image, which is most suitable for the ID card.

Yet further, according to the invention, it is possible to shorten the time for the image taking procedure and also to reduce burden of the ID information Forming Apparatus operator, from the responsibility of adjusting the camera position to place the person's face in a predetermined area before the picture-taking indication.

What is claimed is:

1. An ID information forming apparatus for making ID information to prepare an ID card, comprises:
an image taking section to take a facial image of a person, and to make a first facial image data corresponding to the facial image of the person;
an image information forming section to make first image information from the first facial image data;
an information acquiring section to acquire second image information regarding a second facial image data corresponding to a past facial image of the person;
a checking section to check the first image information against the second image information;
an eye-opening degree judging section to judge a degree of eye-opening of the first facial image data; and
an ID information forming section to form the ID information based on results of checking by the checking section and of judging by the eye-opening degree judging section.

2. The ID information forming apparatus of claim 1, wherein the information acquiring section acquires the second image information from an external server via a network.

3. The ID information forming apparatus of claim 2, wherein the ID information forming apparatus further comprises an inputting section to input personal information for identifying the person, and the information acquiring section acquires the second image information based on the personal information.

4. The ID information forming apparatus of claim 1, wherein the image information acquiring section acquires the second image information by reading a memory of an ID card owned by the person.

5. The ID information forming apparatus of claim 1, wherein the eye-opening degree judging section judges the degree of eye-opening in tandem with the checking by the checking section.

6. The ID information forming apparatus of claim 1, wherein the ID information forming apparatus further comprises a facial image determining section to determine whether the first image information and the second image information being relative to a face of the same person or not based on a result of checking by the checking section, and when the facial image determining section determines the first image information and the second image information are relative to the face of same person, the information forming section forms the ID information.

7. The ID information forming apparatus of claim 1, wherein the image taking section takes plural images of the person and makes plural first facial image data, the eye-opening degree judging section judges the degree of eye-opening of the plural first facial image data, the ID information forming apparatus further comprises an extracting section to extract a facial image data utilized to form the ID information from the plural first facial image data, and the information forming section forms the ID information by utilizing the extracted facial image data.

8. The ID information forming apparatus of claim 1, wherein the ID information forming apparatus further comprises a position adjusting section to adjust a position of the image taking section so as to locate a face of the person in a predetermined area, and comprises a image taking ordering section to order the image taking section to take the facial image when the face of the person being located in the predetermined area.

9. The ID information forming apparatus of claim 1, wherein the first image information is a facial characteristic factor of the first facial image data and the second image information is a facial characteristic factor of the second facial image data, and the checking section checks the facial characteristic factor of the first facial image data against the facial characteristic factor of the second facial image data.

10. The ID information forming apparatus of claim 1, wherein the second image information acquired by the information acquiring section is the second facial image data itself, and the first image information is a facial characteristic factor of the first facial image data, the image information forming section further makes a facial characteristic factor of the second facial image data from the second facial image data, and the checking section checks the facial characteristic factor of the first facial image data against the facial characteristic factor of the second facial image data.

11. An ID information forming method utilizing the ID information forming apparatus of claim 1, comprising:
taking a facial image of a person, and making a first facial image data corresponding to the facial image of the person by the image taking section;
making first image information from the first facial image data by the image information forming section;
acquiring second image information regarding a second facial image data corresponding to a past facial image of the person by the information acquiring section;
checking the first image information against the second image information by the checking section;
judging a degree of eye-opening of the first facial image data by the eye-opening degree judging section; and
forming ID information to prepare an ID card by the information forming section based on results of checking and judging.

12. The ID information forming method of claim 11, wherein
in the step of acquiring the second image information, the second image information is acquired from an external server via a network.

13. The ID information forming method of claim 12, wherein the ID information forming method further comprises a step of inputting personal information for identifying the person; and in the step of acquiring the second image information, the second image information is acquired based on the personal information.

14. The ID information forming method of claim 11, wherein, in the step of acquiring the second image information, the second image information is acquired by reading a memory of an ID card owned by the person.

15. The ID information forming method of claim 11, wherein the step of judging the degree of eye-opening of the first facial image data are conducted in tandem with the step of checking the first image information against the second image information.

16. The ID information forming method of claim 11, wherein the ID information forming method further comprises a step of determining whether the first image information and the second image information being relative to a face of the same person or not by a facial image determining section based on a result of the step of checking; and
when the first image information and the second image information are relative to the face of same person, the ID information is formed by the information forming section.

17. The ID information forming method of claim 11, wherein
in the step of taking the facial image, plural facial images are taken;
in the step of making the first facial image data, plural first facial image data are made;
in the step of judging the degree of eye-opening, the plural first facial image data are judged;
the ID information forming method further comprises extracting a facial image data utilized to form the ID information from the plural first facial image data; and
in the step of forming the ID information, the ID information is formed by utilizing the extracted facial image data.

18. The ID information forming method of claim 11, wherein the ID information forming method further comprises:
adjusting a position of the image taking section so as to locate a face of the person in a predetermined area; and
ordering the image taking section to take the facial image when the face of the person being located in the predetermined area.

19. The ID information forming method of claim 11, wherein when the first image information is a facial characteristic factor of the first facial image data, and when the first image information is a facial characteristic factor of the second facial image data,
in the step of checking, the facial characteristic factor of the first facial image data is checked against the facial characteristic factor of the second facial image data.

20. The ID information forming method of claim 11, wherein when the second image information is the second facial image data itself, and when the first image information is a facial characteristic factor of the first facial image data,
the ID information forming method further comprises a step of making a facial characteristic factor of the second facial image data from the second facial image data by the information forming section; and
in the step of checking, the facial characteristic factor of the first facial image data is checked against the facial characteristic factor of the second facial image data.

21. A ID card preparing system comprises:
the ID information forming apparatus of claim 1;
an image server to store the second facial image data corresponding to the past facial image of the person; and
a printer to print the ID information formed by the ID information forming apparatus on a ID card substrate,
wherein the ID information forming apparatus, the image server and the printer are connected with a network.

22. The ID card preparing system of claim 21, wherein the image server makes the second image information from the second facial image data, and the information acquiring section of the ID information forming apparatus acquires the second image information from the image server.

23. The ID card preparing system of claim 22, wherein the second image information is a facial characteristic factor of the second facial image data, and the first image information is a facial characteristic factor of-the first facial image data.

24. The ID card preparing system of claim 21, wherein the information acquiring section of the ID information forming apparatus acquires the second facial image data as the second image information, the image information forming section forms a facial characteristic factor of the second facial image data, the first image information is a facial characteristic factor of the first facial image data, and the checking section checks the facial characteristic factor of the first facial image data against the facial characteristic factor of the second facial image data.
